(19) United States
(12) Patent Application Publication
(10) Pub. No.: US 2020/0280225 A1
(43) Pub. Date: Sep. 3, 2020

(54) ELECTRIC MACHINE HAVING A LAMELLAR STACK FOR FIXING A MAGNET AND A LAMELLAR STACK FOR USE IN SUCH A MACHINE

(71) Applicant: VOLKSWAGEN AKTIENGESELLSCHAFT, Wolfsburg (DE)

(72) Inventor: LARS WETTERAU, KASSEL (DE)

(21) Appl. No.: 16/755,662

(22) PCT Filed: Sep. 25, 2018
(86) PCT No.: PCT/EP2018/075893

§ 371 Date: Apr. 13, 2020

(30) Foreign Application Priority Data
Oct. 13, 2017 (DE) 10 2017 218 408.6

(51) Int. Cl. H02K 1/27; H02K 15/03; H02K 1/30

(52) U.S. Cl. CPC H02K 1/276; H02K 1/30; H02K 15/03

(57) ABSTRACT

An electric drive machine has a lamellar stack containing a plurality of lamellae, stacked one atop the other, and having a plurality of recesses, in each of which a magnet is fixed. Each magnet is interlockingly and frictionally fixed in the recess, and the individual layered lamellae have a respective protrusion, which has an elastically deformable retaining section, formed by a turn. The retaining section limits the available cross-sectional area such that the magnet can be inserted into the recess against the elastic reset force of the retaining section. To prevent damage to the magnet, the retaining section has a shape projecting in the direction of the recess, which is formed by an embossing contour. Therefore, a contact surface between the retaining section and the magnet has a distance from a plane, defined by an edge region of the retaining section, being greater than the typical extension of stamping burrs.

The invention relates to an electric machine, in particular an electric drive machine of a motor vehicle having a lamellar stack consisting of a plurality of lamellae stacked V one atop the other and designed as sheet metal blanks, in particular for a rotor of the electric machine, the lamellar stack having at least one recess for fixing at least one magnet, several of the lamellae stacked one atop the other having a respective protrusion, which has an elastically deformable retaining section formed by a turning and/or bending, which extends into the region of the recess and limits the circumferential contour or cross-sectional area, so that the magnet is interlockingly and/or frictionally fixed in the recess. Furthermore, the invention relates to a lamellar stack formed from a plurality of lamellae stacked one atop the other for use in such an electric machine.

Electric machines with such lamellar stacks are often used as electric motors in the motor vehicle sector, for example as steering motors or in actuators.

Electric machines excited by permanent magnets essentially have a primary part and a secondary part, which are spaced apart from one another by an air gap. The primary part is the component that has a single-phase or multi-phase winding that can be energized. The secondary part has permanent magnets which have the excitation poles to form the magnetic excitation field.

In the case of rotary machines, the primary part is designed as a stator with a winding and the secondary part as a rotor with permanent magnets. The stator and rotor are typically designed to reduce eddy current losses by means of lamination stacks consisting of a plurality of individual electrical sheets. The rotor is pressed on a steel shaft, for example.

V The rotor has permanent magnets which are arranged either inside the rotor or on the surface of the rotor facing the stator and which are permanently fixed in order to control the mechanical forces under dynamic and static loads during operation of the electric machine and to protect the permanent magnets from damage. The magnets can for example be held on the lamellar stack of the rotor by clamping or gluing.

From DE 100 09 151 C2 it is known to provide, in the case of a synchronous motor, clamping elements attached to the end of the rotor, which initially project radially from the lamination stack and are bent into an axial orientation after the magnets have been inserted, in order to use these axially bent ends to engage in recesses in the magnets.

From DE 10 2007 015 249 A1 it is known to fix magnets by means of additional retaining elements which can be placed on the opposite end faces. For this purpose, axially parallel clamping elements each engage in a groove.

From DE 103 57 502 A1 a rotor is known which is composed in the axial direction of a lamination stack from identically shaped individual sheets, magnets inserted in the receiving pockets of the rotor being held by means of protrusions provided on the narrow sides of the receiving pockets.

In the lamination stack known from DE 10 2007 029 719 A1, pocket openings of individual sheets have on both narrow sides.

In the case of a lamination stack in accordance with EP 2 436 100 B1, a reliable fixing of the magnets is ensured in that in a plurality of single sheets stacked one atop the other a number of pocket openings with molded clamping lugs for clamp fixation of the magnets the individual clamping lugs are provided on opposite opening sides.

From U.S. Pat. No. 5,581,140 receiving pockets with clamping lugs for clamping the magnets are known, the clamping lugs being provided only in every third or fourth sheet layer.

Due to the mechanical fixation of the permanent magnets in the lamination stack, damage to the magnet surface frequently occurs due to the stamping burr, which is inevitable when the stamping contour is introduced into the individual sheets.

Fixations of the permanent magnets in the lamination stack by means of suitable adhesive connections, for example by means of adhesives or by bandage material, are also known. The gap or the cavity between the pocket and the permanent magnet is filled with an impregnating resin.

However, the procedure described does not result in a defined location or position of the permanent magnet in the pocket, possibly causing asymmetries in the electrical or magnetic quantities, such as the course of the magnetic fields of the permanent magnets. The undefined location of the permanent magnets in the pockets can also have a negative impact on the balance quality of the rotor.

Furthermore, the magnet can protect its surface by being overmolded with a suitable plastic material.

Against this background, it is the object of the invention to significantly improve the fixation of the magnet in the lamellar stack in an electric machine of the type mentioned. Furthermore, a lamellar stack intended for use in the electric machine is to be created with an improved fixation of the magnet.

The first-mentioned object is achieved with an electric machine according to the features of claim 1. The dependent claims relate to particularly expedient developments of the invention.

According to the invention, the retaining section has a shape projecting in relation to the main extension plane of the angled and/or bent retaining section in the direction of the recess in relation to a circumferential edge region of the retaining section, which limits the circumferential contour or cross-sectional area. The invention is based on the findings that the magnet can be fixed mechanically without the risk of damaging the surface of the magnet if the contact area of the retaining section spaced apart from its edge region, in particular from its stamping burr, and at the same time with respect to the plane which is determined by the circumferential contour of the retaining section, protrudes, that is to say is projecting in the direction of the magnet to be fixed. In a surprisingly simple manner, it is therefore unnecessary to remove the stamping burrs from the retaining sections, which in practice would result in a considerable additional manufacturing effort. Rather, the shape serves to spatially separate the contact surface from the plane of the stamping burrs, so as to reliably prevent undesired contact with the surface of the magnet. As a result, a coating of the magnet surface as well as a gap between the recess and the magnet to be filled by an adhesive agent can be dispensed with and its positioning accuracy can be improved. The distance therefore corresponds at least to the height of the maximum burr formation that occurs in practice, for example at least 0.2 mm, preferably more than 0.5 mm.

The shape could be achieved by a different material thickness or by applying a layer of material or a coating. In contrast, an embodiment of the invention is particularly advantageous in which the retaining section has an at least substantially constant material thickness and in which the shape is convex at least in sections in the direction of the recess or the surface of the magnet. In this way, a contact surface with the magnet spaced apart from the edge region is created in a particularly simple manner, which, in addition, due to the convex curvature, for example spherical in sections, simplifies the assembly of the magnet significantly preferably by an elastic deformation of the retaining section. For example, the retaining section can have the shape of a spoon.

A particularly preferred embodiment of the invention is also achieved in that the shape is formed by reshaping, for example by 3D bending, pressing or deep drawing, at least a subsection of the retaining section enclosed by the edge region. As a result, the lamella with the retaining section can be produced with little effort by stamping and a subsequent or integrated reshaping process. In particular, this only increases the manufacturing effort to a small extent. In practice, the shape is preferably formed by pressure reshaping, in particular pressing or embossing.

The shape could correspond to the entire surface of the retaining section, so that the stamping burr can also be advantageously deformed in a direction facing away from the later contact area with the magnet. Preferably, the shape has a substantially polygonal, for example rectangular, circumferential contour, so as to allow for a sufficiently large contact area with the magnet. The retaining section is preferably designed as a rectangular protrusion with a constant width.

The shape could have an exclusively curved surface contour in order to simplify the assembly of the magnet. Particularly preferably, the shape has a flat contact surface that can be placed against the magnet. This creates a sufficiently large contact area on the magnet and thereby a safe and positionally precise fixation. In addition, the pressure acting on the magnet can be reduced by a correspondingly enlarged area.

In addition, it has already proven to be particularly practical if the shape has a constant distance from the edge region, so that the desired protection of the magnetic surface against the stamping burr is ensured in particular regardless of the direction of assembly.

The lamellar stack could be constructed from a plurality of lamellae, each of which has a retaining section according to the invention. However, it has already proven to be particularly practical if the lamellar stack has an in particular regular sequence of lamellae each equipped with and without a retaining section, which are arranged spaced apart from one another in the position prepared for mounting the magnet. This reliably prevents an undesired overlap of the retaining sections of different lamellae, the contact surfaces of the respective retaining sections being arranged in a common plane. A suitable modular structure made of lamellae with and without a retaining section means that the lamellar stack can be easily adapted to different magnets and requirements for the required holding force.

The object according to the invention is further achieved with a lamellar stack formed from a plurality of layers stacked one atop the other in that the retaining section has a shape protruding with respect to the main extension plane of the angled and/or bent retaining section in the direction of the recess with respect to a circumferential edge region of the retaining section. As a result, this ensures a sufficient distance between the plane of the edge region of the retaining section, which has stamping burrs for production reasons, and the plane of the retaining or contact area for the magnet by this retaining or contact surface being arranged on the shape protruding in the direction of the magnet. Contacting the surface of the magnet by stamping burrs is therefore excluded, so that the damage which otherwise often occurs can be reliably avoided.

The invention permits numerous embodiments. To further illustrate its basic principle, one of these embodiments is shown in the drawing and is described below.

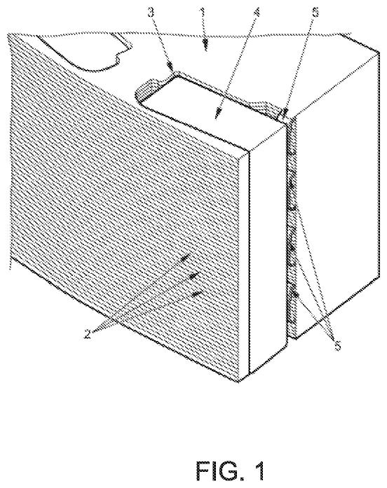

FIG. 1 shows a perspective illustration of a section of a lamellar stack with magnets inserted therein.

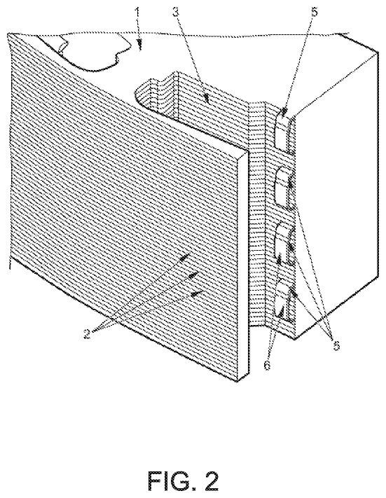

FIG. 2 shows the lamellar stack shown in FIG. 1 without magnets;

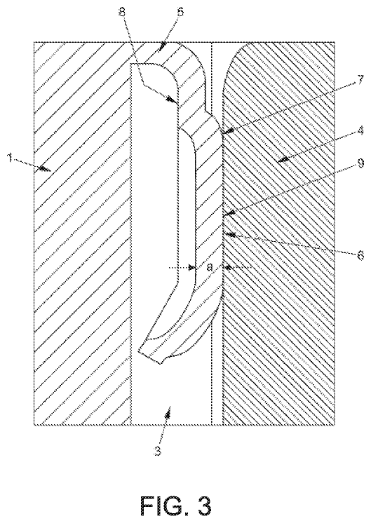

FIG. 3 shows an enlarged side view of a retaining section of the lamellar stack shown in FIGS. 1 and 2;

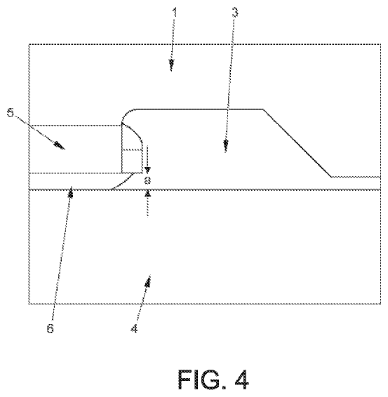

FIG. 4 shows an enlarged plan view of the retaining section;

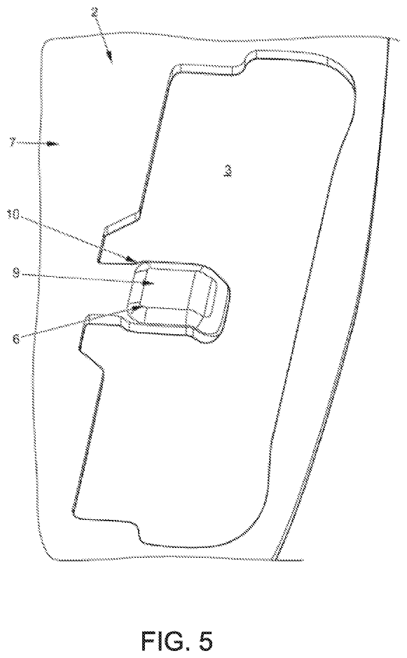

FIG. 5 shows a perspective view of a front side of a lamella of the lamellar stack shown in FIGS. 1 and 2;

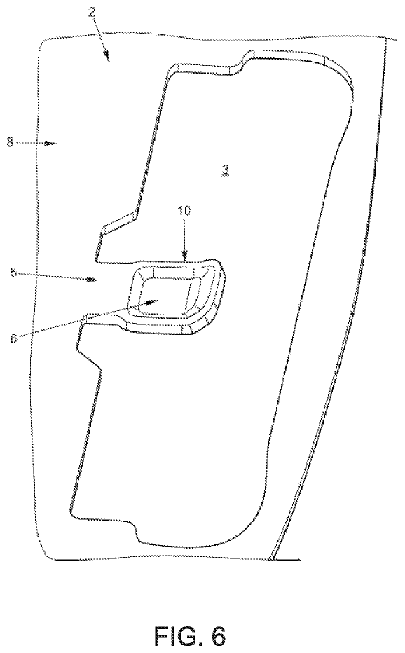

FIG. 6 is a perspective view of a rear side of the lamella shown in FIG. 5.

A lamellar stack 1 for an electric machine, especially an electric drive machine of a motor vehicle will be illustrated in more detail below with reference to FIGS. 1 to 6. Lamellar stack 1 consists of a plurality of lamellae 2, which are stacked one atop the other and designed as a sheet metal blank, and forms, for example, a rotor of the electric machine. The lamellar stack 1 has a plurality of concentrically arranged recesses 3, in each of which a magnet 4 is fixed in the operative position. Each magnet 4 is interlockingly and frictionally fixed in recess 3 associated therewith, in that individual ones of lamellae 2 stacked one atop the other are equipped with a respective protrusion which has an elastically deformable retaining section 5 formed by a bend. This retaining section 5 limits the available cross-sectional area in such a way that magnet 4 can be inserted into recess 3 against the elastic restoring force of retaining section 5. In this way, retaining section 5 limits the circumferential contour. Lamellae 2 are produced in a manner known per se by stamping and have a stamping burr (not shown) along the stamping contour, which can result in damage if it comes into direct contact with the surface of magnet 4. In order to prevent such damage, each of the four retaining sections 5 in the exemplary embodiment has a shape 6 protruding in the direction of recess 3, which is formed by an embossed contour. As can be seen in particular in FIGS. 1 to 4, a convex upper side 7 and concave lower side 8 of the respective retaining section 5 are created, with the result that a contact surface 9 between retaining section 5 and magnet 4 is at a distance a to a plane defined by an edge region 10 of retaining section 5, which is dimensioned larger than the typical extent of stamping burrs. In this way, undesired contact of edge region 10 of retaining section 5 with magnet 4 is effectively avoided in a simple manner, without the need for post-treatment of the stamping contour.

### LIST OF REFERENCE NUMERALS

1 lamellar stack
2 lamellae
3 recess
4 magnet
5 retaining section
6 shape
7 top
8 bottom
9 contact area
10 edge region
a distance

1-10. (canceled)

11. An electric machine, comprising:
at least one magnet; and
a lamellar stack formed from a plurality of lamellae stacked one atop another and configured as sheet metal blanks, said lamellar stack having at least one recess formed therein for fixing said at least one magnet, several of said lamellae stacked one atop another and having a respective protrusion with a retaining section extending into a region of said at least one recess so that said at least one magnet in said at least one recess is interlockingly and/or frictionally fixed in said at least one recess, said retaining section having a shape which projects from a circumferential edge region of said retaining section.

12. The electric machine according to claim 11, wherein said shape is convexly formed at least in sections in a direction of said at least one recess.

13. The electric machine according to claim 11, wherein said shape is formed by reshaping at least one partial region of said retaining section enclosed by said circumferential edge region.

14. The electric machine according to claim 11, wherein said shape is formed by pressure forming.

15. The electric machine according to claim 11, wherein said shape has a substantially polygonal circumferential contour.

16. The electric machine according to claim 11, wherein said shape has a flat contact surface which can be placed against said magnet.

17. The electric machine according to claim 11, wherein said shape is at a constant distance from said circumferential edge region of said retaining section along said circumferential edge region.

18. The electric machine according to claim 11, wherein said lamellar stack has a regular sequence of said lamellae each with said retaining section and of said lamellae each having no said retaining section.

19. The electric machine according to claim 11, wherein adjacent ones of said retaining sections are disposed at a distance from one another.

20. The electric machine according to claim 11, wherein:
the electric machine is an electric drive machine; and
said lamellar stack is configured for a rotor of the electric machine.

21. The electric machine according to claim 11, wherein said shape is formed by pressing or embossing.

22. The electric machine according to claim 11, wherein said shape has a rectangular circumferential contour.

23. A lamellar stack, comprising:
a plurality of lamellae stacked one atop another and configured as sheet metal blanks, the lamellar stack having at least one recess formed therein for fixing at least one magnet, several of said lamellae stacked one atop another and having a respective protrusion with a retaining section extending into a region of said at least one recess so that the at least one magnet in said at least one recess is interlockingly and/or frictionally fixed in said at least one recess, said retaining section having a shape which projects from a circumferential edge region of said retaining section, said retaining section having said shape projecting from a circumferential edge region of said retaining section.
